(19) United States
(12) Patent Application Publication
(10) Pub. No.: US 2026/0103125 A1
(43) Pub. Date: Apr. 16, 2026

(54) CHILD SEAT WITH AN INTEGRATED AND RECESSED MULTI-POSITION RECLINE

(71) Applicant: Evenflo Company Inc., Miamisburg, OH (US)

(72) Inventors: Bryan Ray ADAMS, Beavercreek, OH (US); Alan Wayne BALL, Loveland, OH (US); Joel William WENNERSTROM, Roslindale, MA (US)

(21) Appl. No.: 18/912,313

(22) Filed: Oct. 10, 2024

(51) Int. Cl. B60N 2/28

(52) U.S. Cl. CPC B60N 2/2875; B60N 2/2821

(57) ABSTRACT

Aspects of the present disclosure include a child seat a carriage and base. The child seat allows for smooth adjustments between multiple recline positions, which are facilitated by arcuate portions of the carriage that slidably engage arcuate surfaces of the base. A user can select and secure the carriage at a particular recline position using locking bars that are recessed in the carriage and engaged by a locking element of the base of the child seat.

### BACKGROUND

In the United States, child car seats are required by law and recommended for children of certain ages or sizes. There are many types of car seats available for purchase and safety requirements depend on the age and/or size of the child. For example, infants and toddlers under a certain size are recommended to be in rearward-facing car seats, and as the child is big enough, the child may sit in a forward-facing seat.

### BRIEF DESCRIPTION OF THE DRAWINGS

The foregoing and other features of the present disclosure will become more fully apparent from the following description and appended claims, taken in conjunction with the accompanying drawings. Understanding that these drawings depict several examples in accordance with the disclosure and are, therefore, not to be considered limiting of its scope, the disclosure is described with additional specificity and detail below through the use of the accompanying drawings.

FIG. 1 depicts a front perspective view of a juvenile seat in accordance with one or more aspects herein;

FIG. 2 depicts a rear perspective view of the juvenile seat of FIG. 1, in accordance with one or more aspects herein;

FIG. 3 depicts a exploded front perspective view of a juvenile seat, in accordance with one or more aspects herein;

FIG. 4 depicts a rear perspective view of the carriage, in accordance with one or more aspects herein;

FIG. 5 depicts a front perspective view of the base anchor, in accordance with one or more aspects herein;

FIG. 6 depicts a front perspective view of the carriage with some features of the carriage being removed or omitted for visibility of locking bars, in accordance with one or more aspects herein;

FIG. 7 depicts a rear perspective view of the carriage with some features of the carriage removed or omitted for visibility of locking bars and arcuate portions, in accordance with one or more aspects herein;

FIG. 8 depicts a cross-section of the carriage with some features of the carriage removed or omitted for visibility of locking bars, in accordance with one or more aspects herein;

FIG. 9. depicts a front perspective view of the base anchor with some features of the base anchor removed or omitted for visibility of arcuate surfaces and a locking element, in accordance with one or more aspects herein;

FIG. 10 depicts a detail of FIG. 10 as illustrating a roller and an arcuate surface of the base anchor, in accordance with one or more aspects herein;

FIG. 11 depicts a cross section of the detail of FIG. 10, in accordance with one or more aspects herein;

FIG. 12. depicts a front perspective view of the locking element of the base anchor in a locked position as engaging the locking bars of the carriage, in accordance with one or more aspects herein;

FIG. 13 depicts a bottom-up plan perspective view of the base anchor, in accordance with one or more aspects herein;

FIG. 14 depicts a detail of FIG. 12 showing the locking element in the locked position as engaging a locking bar, in accordance with one or more aspects herein;

FIG. 15 depicts a front perspective view of the locking bars of the carriage in an unlocked position as disengaging the locking bars of the carriage, in accordance with one or more aspects herein;

FIG. 16 depicts a bottom-up plan view of the locking element of the base anchor in an unlocked position as disengaging the locking bars of the carriage, in accordance with one or more aspects herein;

FIG. 17 depicts a detail view of FIG. 15 showing a locking element in the unlocked position as disengaging the locking bar, in accordance with one or more aspects herein;

FIG. 18 depicts a right plan view of the carriage of the juvenile seat in a first recline position, in accordance with one or more aspects herein;

FIG. 19 depicts a right plan view of the carriage of the juvenile seat in a second recline position, in accordance with one or more aspects herein;

FIG. 20 depicts a right plan view of the carriage of the juvenile seat in a third recline position, in accordance with one or more aspects herein.

### DETAILED DESCRIPTION

In the following detailed description, reference is made to the accompanying drawings, which form a part hereof. In the drawings, similar symbols identify similar components, unless context dictates otherwise. The illustrative examples described in the detailed description and drawings are not meant to be limiting and are for explanatory purposes. Other examples may be utilized, and other changes may be made, without departing from the spirit or scope of the subject matter presented herein. It will be readily understood that the aspects of the present disclosure, as generally described herein and illustrated in the drawings, may be arranged, substituted, combined, and designed in a wide variety of different configurations, each of which are explicitly contemplated and form a part of this disclosure.

It should be noted that some of the terms used herein may be relative terms. For example, the terms “upper” and “lower” and the terms “forward” (or “front”) and “rearward” (or “rear” or “back”) are relative to each other in location, i.e., an upper component is located at a higher elevation than a lower component in a given orientation, but these terms may change if the device is flipped. An intermediate component, on the other hand, is always located between an upper component and a lower component regardless of orientation. The terms “horizontal” and “vertical” are used to indicate direction relative to an absolute reference, i.e., ground level. However, these terms should not be construed to require structures to be absolutely parallel or absolutely perpendicular to each other. For example, a first vertical structure and a second vertical structure are not necessarily parallel to each other. The terms “top” and “bottom” are used to refer to surfaces where the top is always higher than the bottom relative to an absolute reference, i.e. the surface of the earth when the component is used as intended. The terms “upwards” or “upwardly” and “downwards” or “downwardly” are also relative to an absolute reference; upwards is always against the gravity of the earth. The terms “forward” and “rearward” or “rear” with respect to a position or orientation are opposite one another along a common direction, and an “intermediate” position is always located between a forward position and a rearward position.

The terms “operative to” and “configured to” and similar terms are used herein to describe that a particular component has certain structural features designed to perform a designated function. Such components should be construed as having the expressed structure, with the designated function being considered part of the structure. As used herein and as will be appreciated by those skilled in the art, the term “car seat” and “juvenile seat” are used herein interchangeably to encompasses car seats, safety seats, restraints, boosters, and the like for children, infants, toddlers, and the like.

Unless indicated otherwise, all measurements provided herein are taken when a component(s) is at standard ambient temperature and pressure (298.15 K and 100 kPa). As used herein, the terms “substantially” and “about” mean within ±5% of an indicated value.

Recline positions in juvenile seats are important for optimizing safety and comfort during travel in a vehicle. Proper recline angles, which vary according to the child's age, size, and the seat type, help maintain correct alignment of the child's head, neck, and spine, minimizing the risk of injury in the event of a collision or other impact. For rear-facing seats, a greater reclined position reduces the risk of head flopping forward and provides better protection for the child's head and neck. As the child transitions to a forward-facing seat, adjusting the recline ensures that the harness system remains properly aligned with the child's body, enhancing safety and comfort. Adhering to guidelines for recline positions ensures compliance with safety standards and improves the effectiveness of the juvenile seat in protecting the child during travel and ensures compliance with crash safety standards. One safety function of the recline feature in forward-facing juvenile seats is to manage the dynamic forces experienced during a collision and to maintain or enhance the proper positioning of the child to prevent injury.

Aspects herein provide a juvenile safety seat that allows multiple recline positions using a lockable reclining mechanism. Proper recline angles (also referred to as “positions”) ensures that the harness system remains in optimal alignment with the child's shoulder and hip positions. Incorrect recline angles can lead to suboptimal harness fit, increasing the risk of injury due to improper force distribution. The recline position further affects the juvenile seat's ability to absorb and manage crash forces. A correctly reclined seat mitigates the forward movement of the child's head and torso during a frontal collision, reducing the risk of head and neck injuries. The recline angle helps in distributing crash forces more evenly across the child's body, enhancing overall protection.

The lockable reclining mechanism of the juvenile seat discussed herein enables fine-tuning of the recline position, as said angle impacts the trajectory of force transfer during a crash, influencing how the seat's internal harness and child's body absorb and distribute impact forces. Further, the lockable reclining mechanism can be securely locked, thus rigorously maintaining the selected recline angle while loading bearing and preventing unintended adjustment during travel. The lockable reclining mechanism facilitates proper alignment of a child in the juvenile seat at the selected recline position. Thus, the lockable reclining mechanism ensures the juvenile seat maintains the desired recline position throughout travel and enhances the overall protective capacity of the juvenile seat. Additional, the lockable reclining mechanism remains robust against wear-and-tear while providing improved recline angle ranges. In other words, an increased and improved overall range of seating angles is availability. Within that range, the lockable reclining mechanism offers a greater quantity of distinct recline positions, which allows for fine-tuning the recline position of the child in the juvenile seat. The lockable reclining mechanism is also easy to adjust based on an accessible release handle and the use of slidably engaged arcuate features.

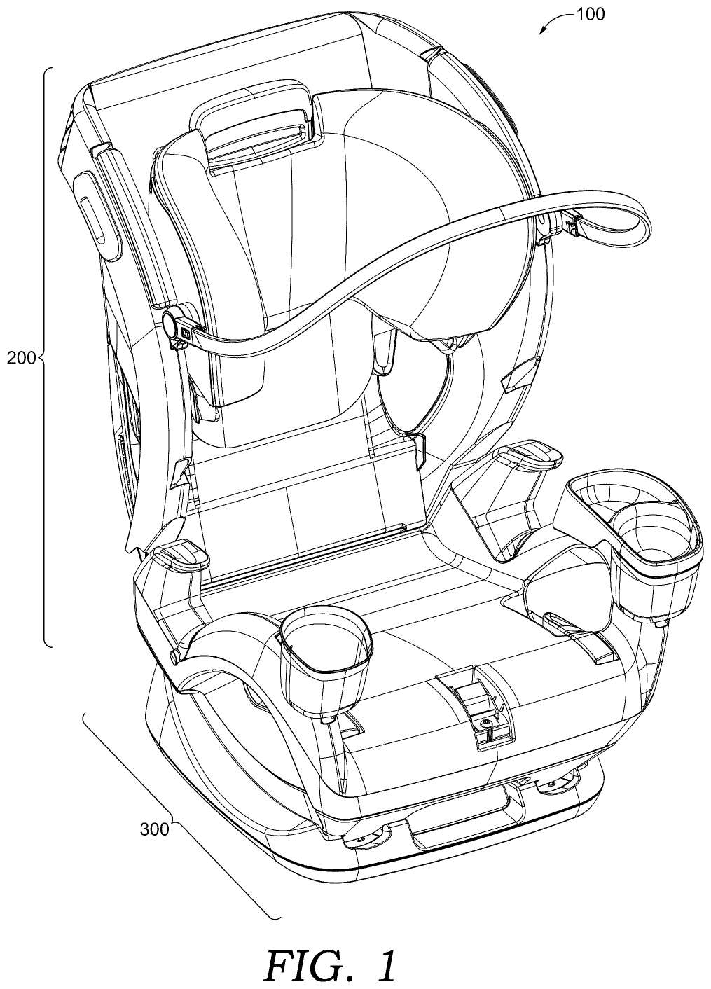

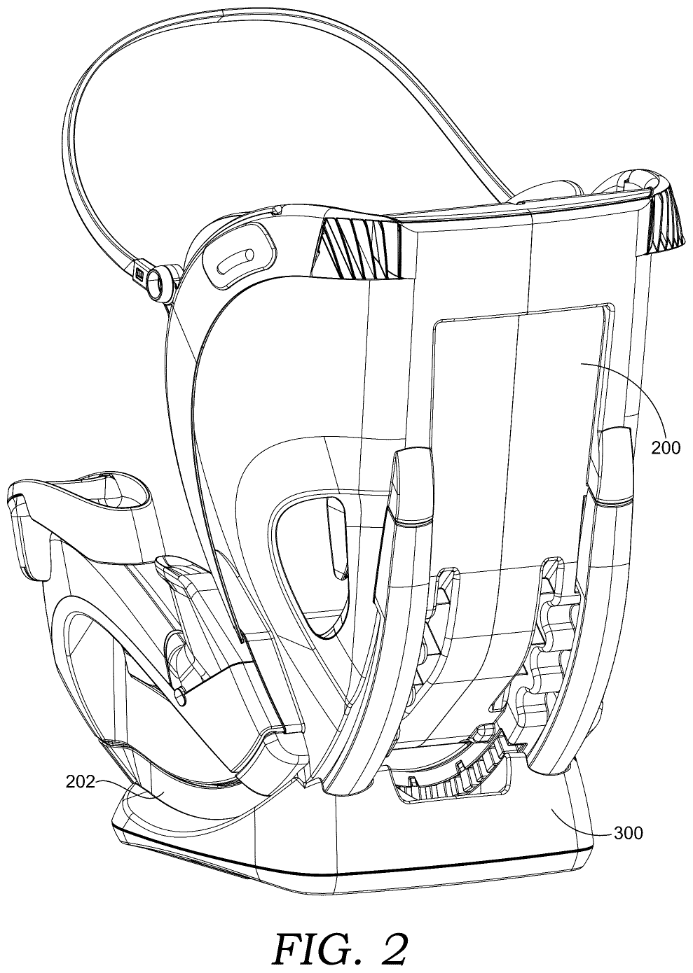

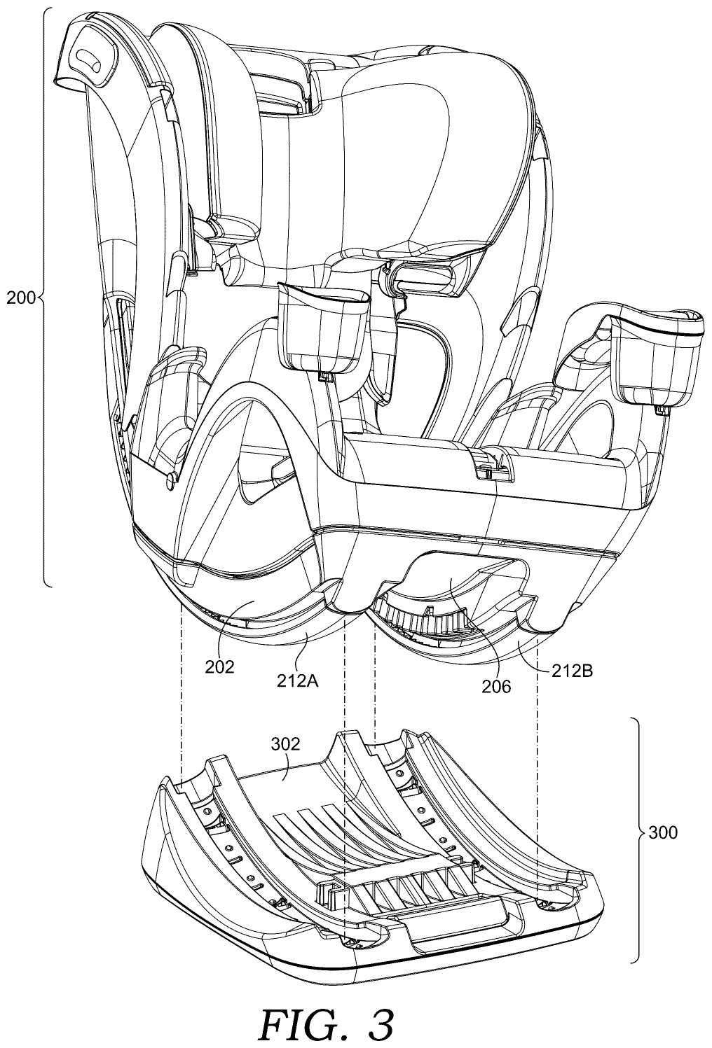

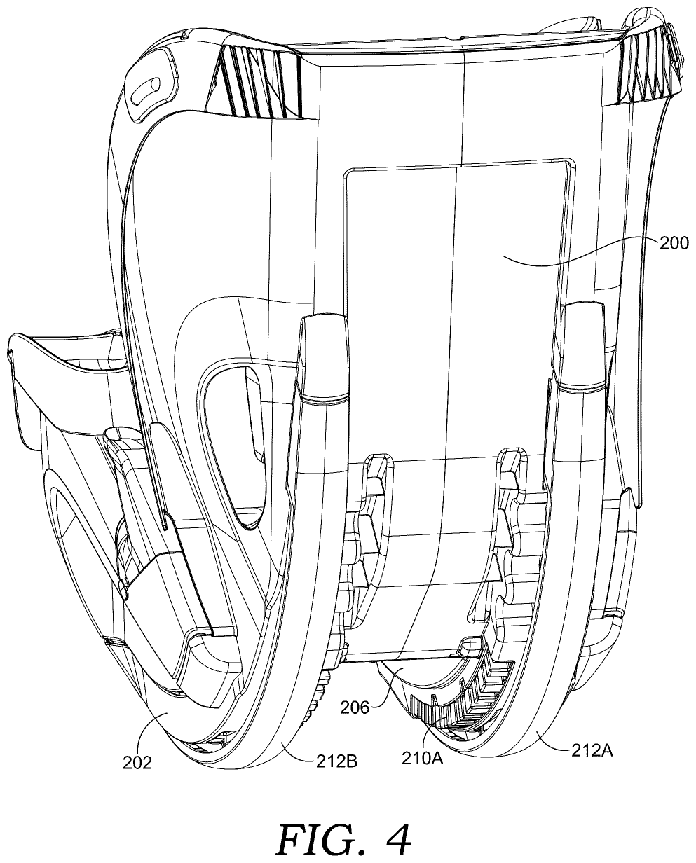

FIG. 1 depicts a front perspective view of a juvenile seat 100 in. The juvenile seat 100 comprises a carriage 200 and a base anchor 300, as shown. FIG. 2 depicts a rear perspective view of the juvenile seat 100 of FIG. 1. The carriage 200 is secured with and moveable relative to the base anchor 300 to allow for multiple recline positions. FIG. 3 depicts an exploded front perspective view of the juvenile seat 100. The carriage 200 includes a platform 202 having an upper surface 204 visible in FIG. 3 and a lower surface 206 visible in the rear perspective view of FIG. 4. Further, the carriage 200 includes a recess that passes through both of the upper surface 204 of the platform 202 and the lower surface 206 of the platform 202. The carriage 200 depicted herein is shown as having two recesses, though more than two recesses or only one recess may be used in various aspects. As visible in FIG. 4, the juvenile seat 100 includes one or more locking bars, shown as locking bars 210a and 210b. Though the example shown has two locking bars, though more than two locking bars or only one locking bar may be used in various aspects. The locking bars 210a and 210b are curvilinear in shape, and are arranged to be parallel to one another, in some aspects. In one example, the locking bar 210a is positioned in the recess 208a while locking bar 210b is positioned in the recess 208a of the carriage 200. Specifically, the locking bars 210a and 210b are partially exposed through the lower surface 206 of the platform, while also being held and retained within the recesses 208a and 208b. In this way, the locking bars 210a and 210b are integrated into the carriage 200 in a non-removable manner, in aspects. In some aspects, the juvenile seat 100 includes two or more locking bars, whereas in other aspects, only one locking bar may be utilized. In some aspects, the quality of recesses matches the quantity of locking bars, such that each locking bar fits into and is retained by a corresponding recess.

The juvenile seat 100 further includes at least one arcuate portion positioned at the rear of the carriage 200. In FIG. 4, the juvenile seat 100 is shown with the arcuate portions 212a and 212b that extend from the rear of the carriage 200 downward to the lower surface 206 of the platform 202. The arcuate portions 212a and 212b protrude outward from the rear surface of the carriage 200 and follow the contour of the rear surface to form an arc-shape along their length; thus the arcuate portions 212a and 212b are curvilinear in shape. The arcuate portions 212a and 212b are arranged to be parallel to one another along their length, in aspects. Additionally, the arcuate portions 212a and 212b have a convex cross-section, such that that have a substantially rounded or elliptical cross-section, in various aspects. The locking bars 210a and 210b may be positioned medially to the arcuate surfaces 304a and 304b, such that the locking bars 210a and 210b are flanked by the arcuate surfaces 304a and 304b in a lateral direction.

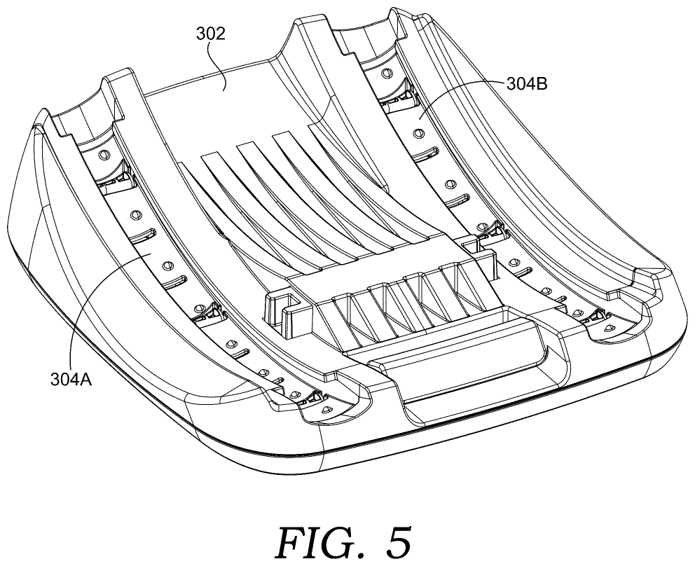

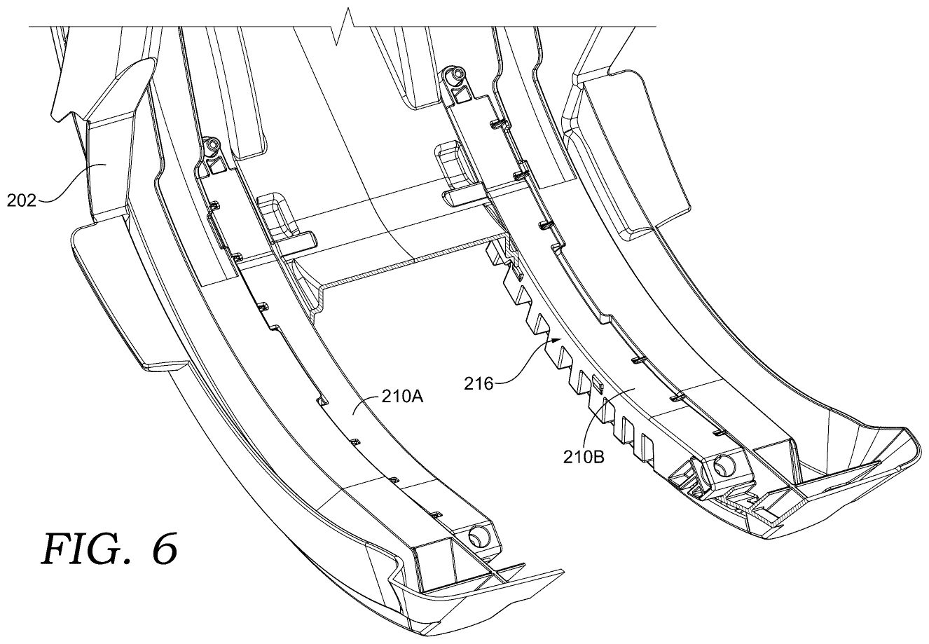

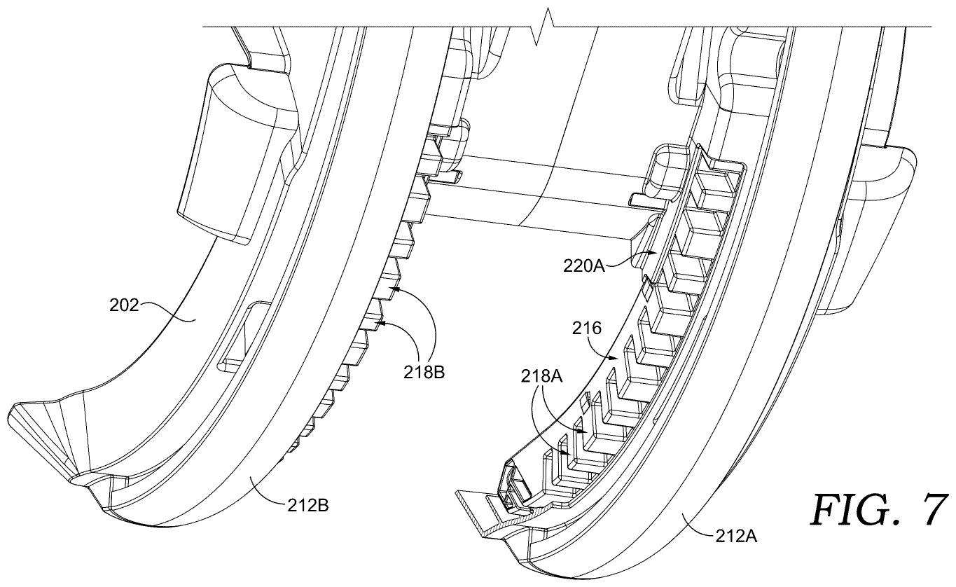

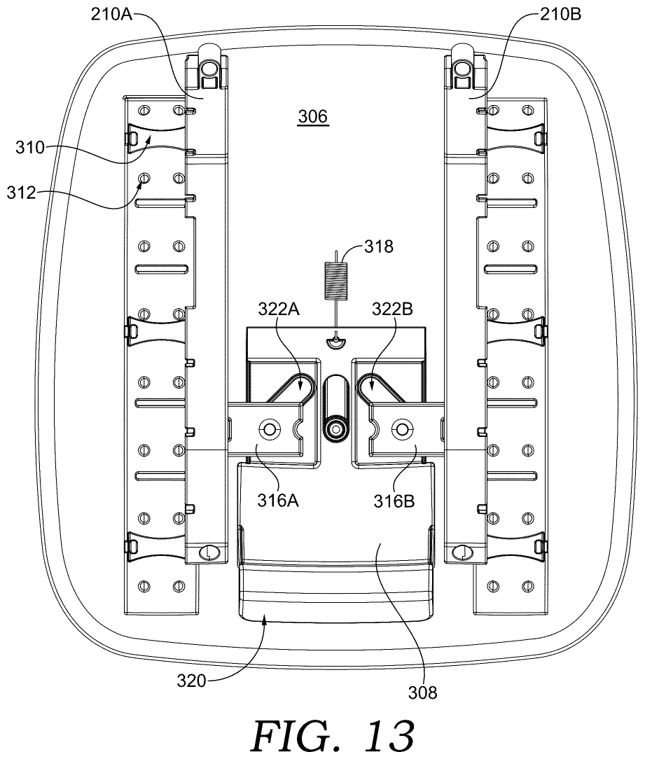

The base anchor 300 includes an upper surface 302, the upper surface 302 having an arcuate surface. In FIG. 5, the upper surface 302 includes arcuate surfaces 304a and 304b, as well as locking element 308. The arcuate surfaces 304a and 304b of the base anchor 300 are sized, shaped, positioned, and aligned so as to engage with, respectively, the arcuate portions 212a and 212b of the carriage 200. For example, the arcuate surfaces 304a and 304b are convex and recessed into the upper surface 302. The convex-shape of the arcuate portions 212a and 212b fit into the concave-shape of the arcuate surfaces 304a and 304b, such that the arcuate portions 212a and 212b may slidably engage each other (i.e., the arcuate portion 212a slidably engages the arcuate surface 304a, and the arcuate portion 212b slidably engages the arcuate surface 304b). For example, FIG. 6 depicts a front perspective view of the carriage and FIG. 7 depicts a rear perspective view of the carriage with some features of the carriage removed or omitted for visibility the arcuate portions and the locking bars. The shape or cross-sectional “profile” of the arcuate portions 212a and 212b is such that the arcuate portions 212a and 212b project outward and fit into the arcuate surfaces 304a and 304b. These shapes and placement enable the carriage 200 to be slidably moved relative to the base anchor 300. As such, a recline position may be selected by sliding and then locking that selected position into place using the locking element 308, as discussed further herein. The base anchor 300 also includes a lower surface 306 (see FIG. 13) which directly contacts a vehicle seat when the juvenile seat 100 is installed within a vehicle.

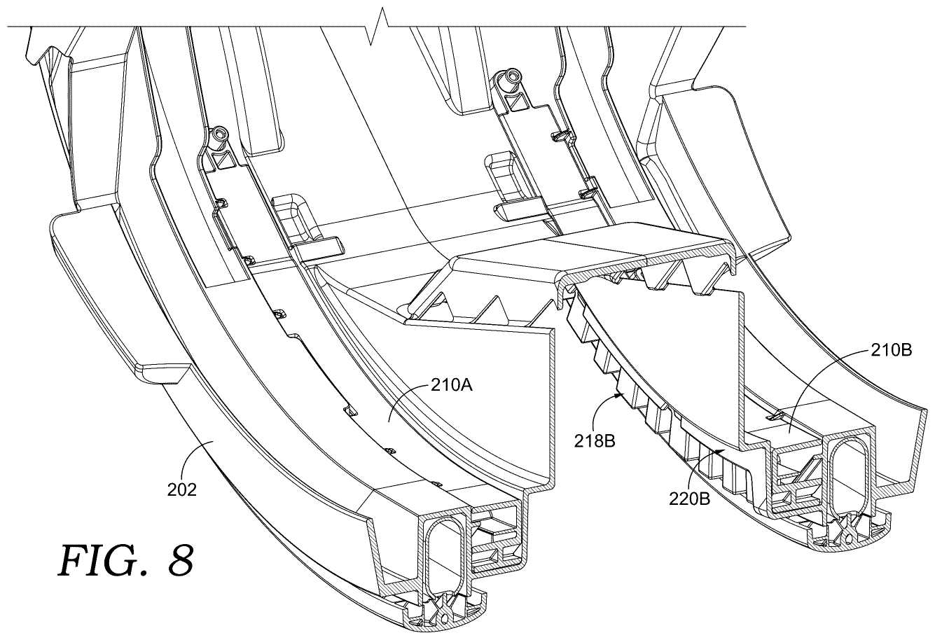

While the arcuate portions 212a and 212b contact the arcuate surfaces 304a and 304b when the carriage is connected to the base anchor 300, the locking bars 210a and 210b do not come into contact with the upper surface 302. For example, in FIGS. 6 and 7 the locking bars 210a and 210b are shown with portions of the lower surface 206 being removed for visibility. The locking bars 210a and 210b are permanently coupled to the frame 214 of the carriage 200. As held with the recesses 208a and 208b, the locking bars 210a and 210b may comprise a rack. As shown in the example of FIGS. 6 and 7, the locking bars 210a and 210b include a portion configured as a rack, see racks 216a and 216b, in aspects. Each of the racks 218a and 218b may have a plurality of teeth 218a and 218b. As such, a portion of the racks 216a and 216b are arranged in the recesses 208a and 208b so that one or more of the plurality of teeth are exposed through the openings formed at the lower surface 206. As shown in FIG. 8, each of the recesses 208a and 208b has a flange, shown as flanges 220a and 220b that forms an opening at the lower surface 206. One or more of the plurality of teeth 218a and 218b of the racks 216a and 216b are exposed through the apertures at the lower surface 206. The flanges 220a and 220b may act as a lip that extends partially over the locking bars 210a and assists in protecting, housing, and/or retaining the locking bars 21a and 210b within the carriage 200. The locking bars 210a and 210b are capable of selectively fixing a moveable position of the carriage 200 relative to the base anchor 300 by mechanically engaging the locking element 308, when a desired reclining position has been selected.

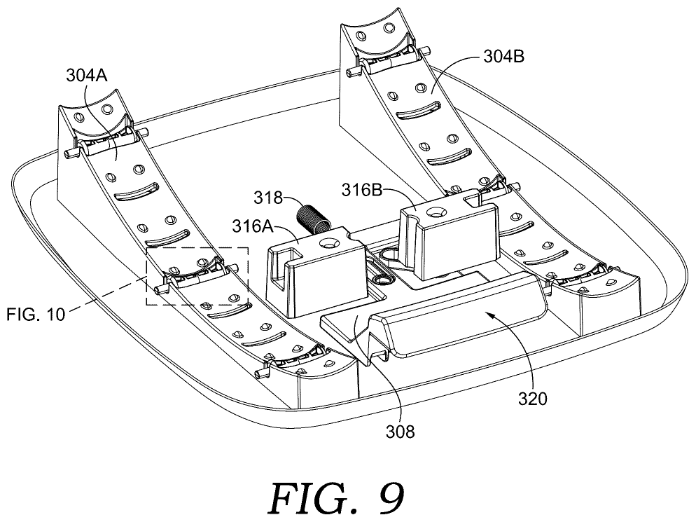

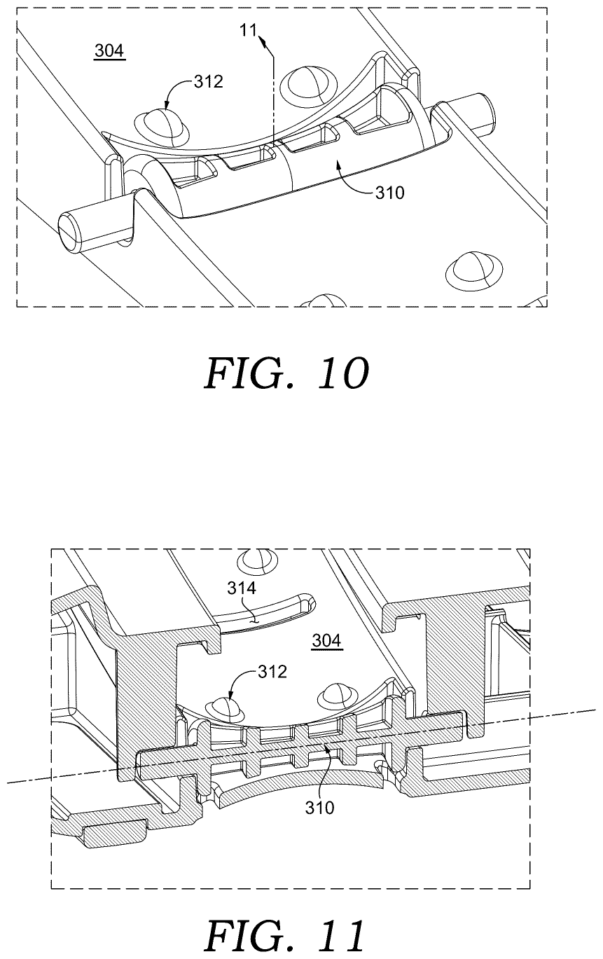

In order to select a desired recline, the arcuate portions 212a and 212b are slidably moved along the arcuate surfaces 304a and 304b. Though the shape of the arcuate surfaces 304a and 304b assists in slidably engaging the arcuate portions 212a and 212b, the arcuate surfaces 304a and 304b may also include one or more rollers and/or one or more projections or “bumps” to reduce friction. In FIG. 9, a front perspective view of the base anchor 300 is shown with the upper surface 302 being removed for improved visibility of the arcuate surfaces 304a and 304b, the locking element 308, and a plurality of rollers 310. In FIG. 9, a plurality of rollers 310 are positioned within the arcuate surfaces 304a and 304b. Although shown as a plurality, any quantity (e.g., one, two, three, etc.) of rollers could be utilized, at any interval and/or grouping along the length the arcuate surfaces 304a and 304b, and the positioning or placement of said rollers in the within the arcuate surfaces 304a and 304b may be varied. In one example, each of the arcuate surfaces 304a and 304b includes at least one roller, said roller being located at or adjacent to the lowest or lower-most surface point of the corresponding arcuate surfaces 304a and 304b that slidably engages with an arcuate portions 212a and 212b. The plurality of rollers 310 may be recessed into the arcuate surfaces 304a and 304b and shaped such that the rollers may freely rotate about a center axis of said roller, where that axis is orthogonal to the length of a respective arcuate surface, as shown in FIGS. 10 and 11. For example, the plurality of rollers 310 may be concave cylinders, wherein the concave shape in configured so that the roller surface is substantially flush with the shape of the arcuate surface. In this manner, when the arcuate portions 212a and 212b slide along the arcuate surfaces 304a and 304b, the plurality of rollers 310 may rotate or spin along their lengthwise axis, which reduces friction between the arcuate portions 212a and 212b and the arcuate surfaces 304a and 304b and thus reduces the force used to move the carriage 200 relative to the base anchor 300. Additionally, the concave exterior surface of a roller assists in centering the arcuate portions 212a and 212b relative to the arcuate surfaces 304a and 304b. The arcuate surfaces 304a and 304b may include one or more openings 312, in some aspects like that shown, which capture and allow debris to be removed from the arcuate surfaces 304a and 304b by passing through the openings 312.

Additionally or alternatively, a plurality of projections 314 may be arranged to protrude from the arcuate surfaces 304a and 304b, as also shown in FIGS. 9-11. When the arcuate portions 212a and 212b slide along the arcuate surfaces 304a and 304b, the plurality of projections 314 displace the arcuate portions 212a and 212b upward and away from the arcuate surfaces 304a and 304b. This reduces contact between the arcuate portions 212a and 212b and the corresponding arcuate surfaces 304a and 304b, which in turn reduces friction and reduces the force used to move the carriage 200 relative to the base anchor 300.

In various aspects, the base anchor 300 may lack any rollers while having projections, may lack projections while having rollers, may lack both rollers and projections, or may have both rollers and projections. Although discussed as a plurality, it will be understood that only one roller and/or one projection might be utilized in various aspects, such that the quantity shown in the figures is merely one example. Similarly, the positioning of the roller(s) and/or projection(s) relative to the arcuate surfaces 304a and 304b may be varied to different effect. For example, a roller might be positioned at or adjacent to a lowest point of the arcuate surfaces 304a and 304b, as the placement may contribute to improved friction reduction, particularly when the carriage 200 is load bearing.

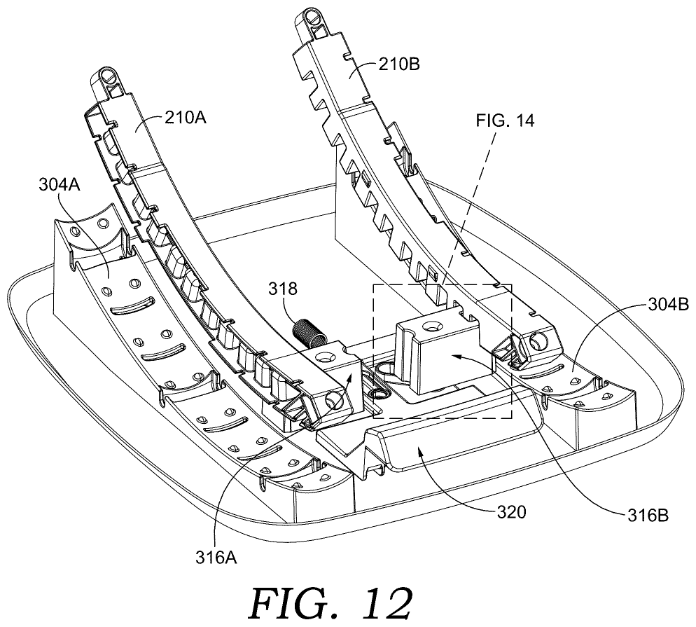

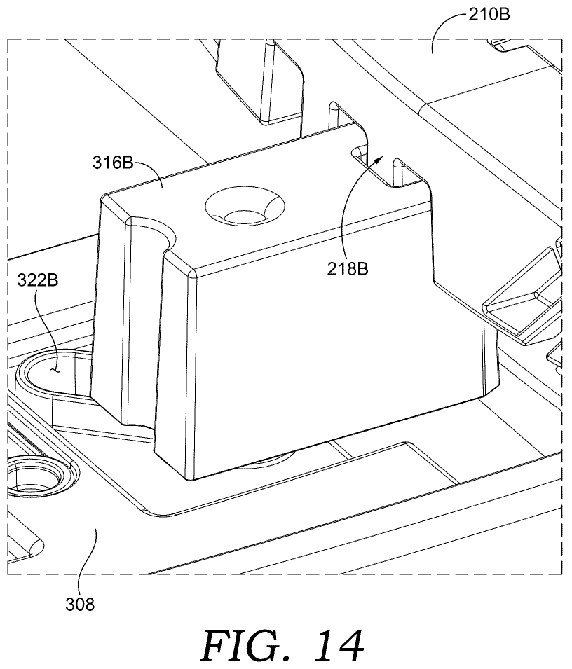

Accordingly, because the arcuate portions 212a and 212b slidably engage with the arcuate surfaces 304a and 304b so that the carriage 200 may be easily and smoothly relined, the base anchor 300 and the carriage 200 further comprising locking features so that a particular recline may be maintained and securely locked into place. For example, FIG. 12. depicts a front perspective view of the locking element 308 of the base anchor 300 engaging the locking bars 210a and 210b of the carriage, while FIG. 13 depicts a bottom-up plan perspective view of the base anchor 300 and the locking element 308 engaging the locking bars 210a and 210b of the carriage. FIG. 14 depicts a detailed view of FIG. 12, showing a portion of the locking element 308 engaging a respective locking bar. The locking element 308 comprises at least one engagement projection, shown as engagement portions 316a and 316b. The engagement portion(s) is/are configured to mechanically engage the locking bar in order to selectively fix a moveable position of the carriage relative to the base anchor. As shown in FIGS. 12 through 14, for example, the engagement portions 316a and 316b mechanically engage the locking bars 210a and 210b to selectively fix the movable position of the carriage 200 relative to the base anchor. For example, the engagement portions 316a mechanically engages one or more of the plurality of teeth 218a while the engagement portions 316b mechanically engages one or more of the plurality of teeth 218b to selectively fix a moveable position of the carriage 200 relative to the base anchor 300. In the example shown, the engagement portions 316a and 316b have a size and shape that is configured to at least partially mate with the size and shape of the plurality of teeth 218a and 218b of the racks 216a and 216b of the locking bars 210a and 210b. Based on the position of one or more of the plurality of teeth 218a and 218b that are mechanically engaged by the engagement portions 316a and 316b, respectively, the reclining position of the carriage relative to the base anchor 300 is determined. For example, when teeth positioned nearer the front-most terminal portion of a locking bar are engaged, it results in a reclining angle of the carriage 200 that is less reclined than a reclining angle resulting when teeth positioned nearer the rear-most terminal portion of a locking bar are engaged. Thus, the plurality of teeth 218a and 218b are capable of being mechanically engaged by the engagement portions 316a and 316b to selectively fix a moveable position, from among a plurality of available positions, of the carriage 200 relative to the base anchor 300. The quantity and spacing of the teeth along the length of a corresponding rack provides for numerous recline positions to be selected, and allows a user to select a fine tune the desired position.

The locking element 308 further comprises a biasing member 318 and a handle 320, wherein the biasing member 318 biases the handle 320 to selectably modify the locking element to mechanically engage the locking bar. The biasing member 318 is coupled to the locking element 308 within the base anchor 300 and positioned opposite the handle 320, shown in FIG. 13.

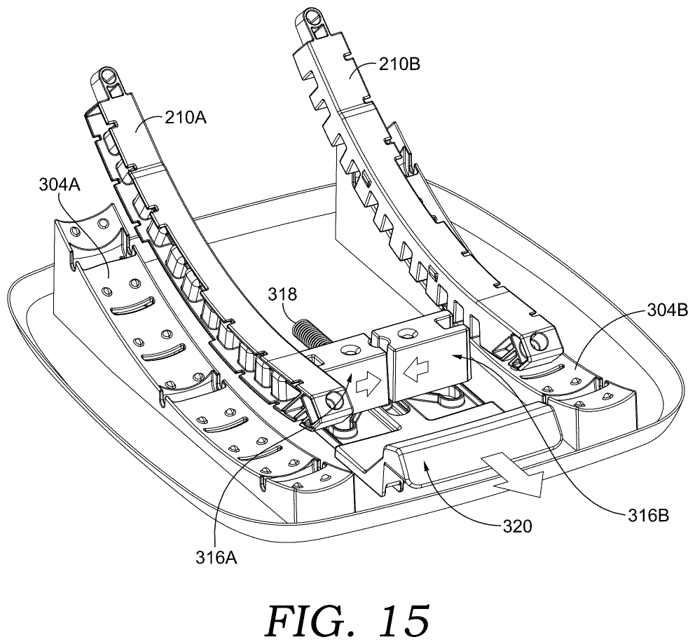

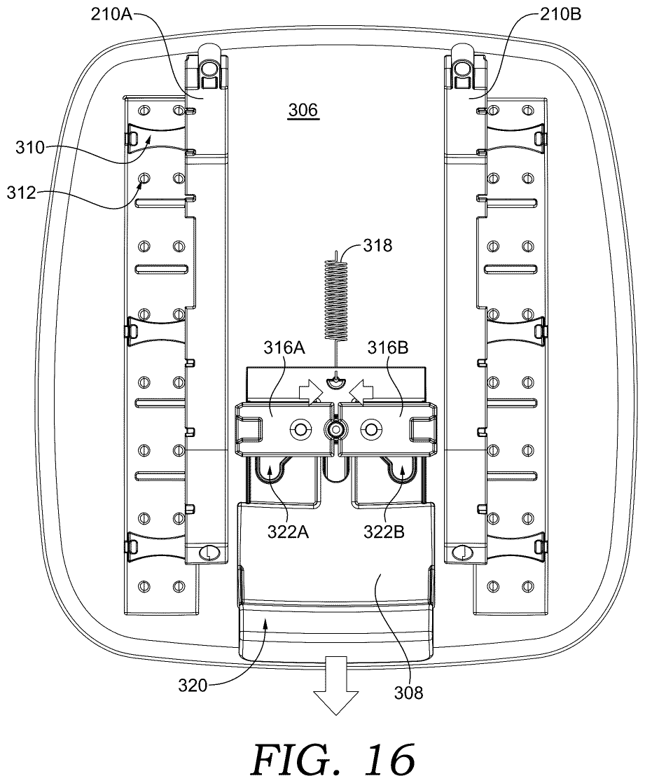

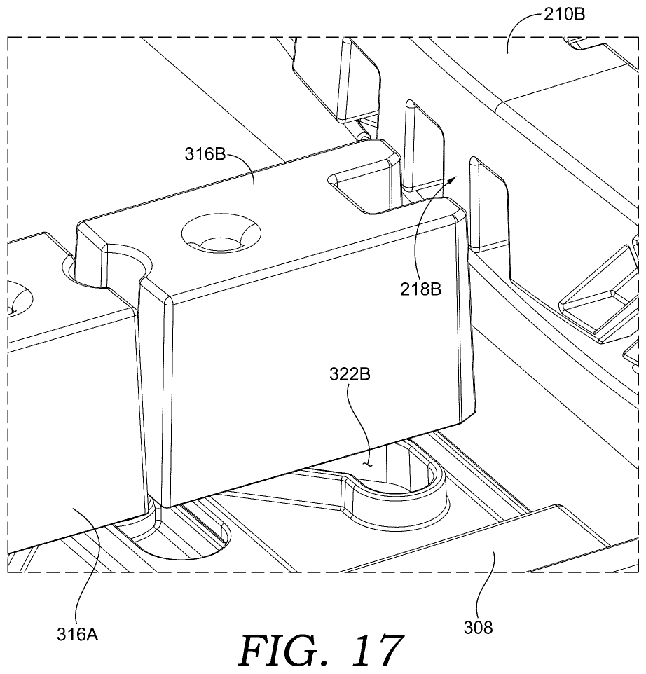

When the handle 320 is pulled outward toward the front of the base anchor 300 as shown in FIG. 15, the biasing member 318 is tensioned by stretching as shown in FIG. 16, relative to the un-stretched state of the biasing member 318 shown in FIG. 13. At the same time, a portion of the engagement portions 316a and 316b extend into corresponding slots 322a and 322b, which caused movement. Due to the angle of the slots 322a and 322b, the engagement portions 316a and 316b are slide within the slots 322a and 322b toward one another as the handle 320 moves forward and places the biasing member 318 into the tensioned state of FIG. 16. This slides the engagement portions 316a and 316b from a lateral position where the engagement portions 316a and 316b mechanically engage the plurality of teeth 218a and 218b, to a more medial position as shown in FIG. 16, where the engagement portions 316a and 316b release the plurality of teeth 218a and 218b and therefore no longer engage the locking base 210a and 210b. FIG. 17 depicts a detailed view of an engagement projection of the locking element 308 in a medial position within a corresponding slot, and as not engaging any teeth of the rack of a locking bar.

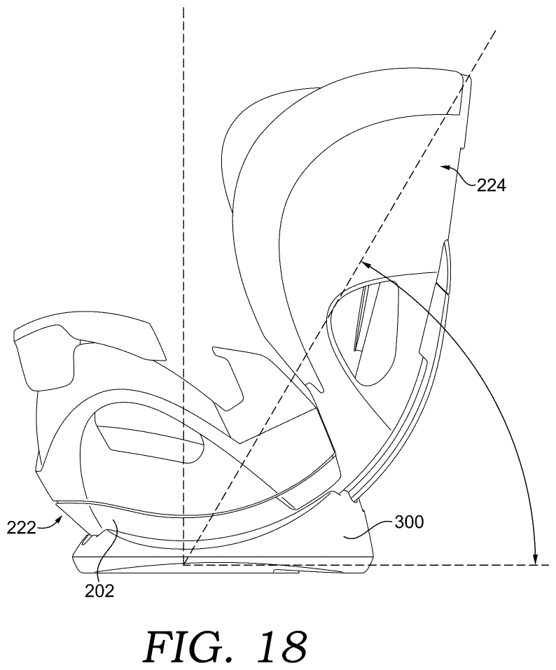

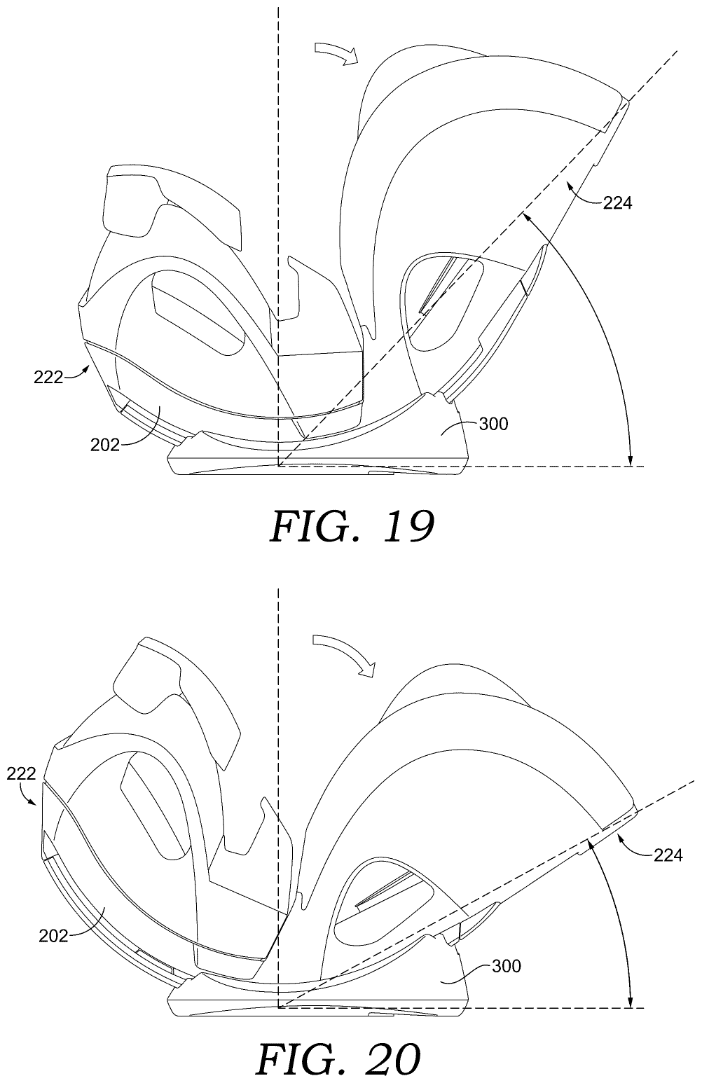

Thus, when the locking bars are 210a and 210b are not mechanically engaged by the locking element 308, the carriage 200 is moveable relative to the base anchor 300 based on the arcuate portions 212a and 212b slidably engaging the arcuate surfaces 304a and 304b of the base anchor 300. When not engaged, the carriage 200 may be moved from one recline position to another. For example, FIG. 18 depicts a right plan view of the carriage 200 of the juvenile seat in a first recline position (e.g. shown as “upright” with the least amount of recline), while FIG. 19 depicts a right plan view of the carriage 200 of the juvenile seat in a second recline position, which is greater in recline that the first recline position. Notably, a forward end 222 of the platform 202 is moved downward relative to the base anchor 300 and a headrest portion 224 of the carriage 200 moves upward relative to the base anchor 300 in the second reclining movement. Further, a seating angle of the carriage is maintained constant so that the hip angle of an occupant is maintained, while the tilt-in-space angle changes. The “tilt-in-space” angle refers to the angle measured between the rear of the carriage 200 relative to the lower surface 306 of the base anchor 300. In contrast, the “seating angle” refers to the interior angle measured between the headrest portion 224 of the carriage 200 and the seating area of the carriage 200, which corresponds to the location where a child would be held within the carriage 200. The terms “seating angle” and “back angle recline” may be used interchangeably herein.

Continuing, by releasing the handle 320, the locking bars 210a and 210b become mechanically engaged by the locking element 308 which secures the carriage 200 in the second recline position, for example, as shown in FIG. 19. When the handle 320 is released, the biasing member 318 returns to a naturally un-tensioned and un-stretched state, based on its own structural tension (e.g., coils of a spring). For example, the example of a spring as a biasing member 318 is shown in FIG. 13 in a coiled, un-stretched state in FIG. 13 and the pull of the biasing member 318 returning to its naturally un-tensioned and un-stretched state that applies a force to pull the handle 320 toward the rear of the base anchor 300.

When the handle 320 is pulled by the biasing member 318 after release, the engagement portions 316a and 316b slide within the slots 322a and 322b, the positioning, angle, and orientation of said angle facilitates moving the engagement portions 316a and 316b from a medial position (where the engagement portions 316a and 316b do not engage the plurality of teeth 218a and 218b) to a lateral position (where the engagement portions 316a and 316b mechanically engage the plurality of teeth 218a and 218b of the locking bars 210a and 210b). Thus, the handle 320 is configured to be used for selectably modifying the locking element 308 from a position that mechanically engages the locking bars 210a and 210b to another position that disengages the locking bars 210a and 210b. In an example, the carriage 200 may be further moved from the second recline position shown in FIG. 19 into a third, deeper recline position shown in FIG. 20 by pulling on the handle 320 and sliding the arcuate portions 212a and 212b along the arcuate surfaces until a desired recline position is reached. Then, by releasing the handle 320 and allowing the biasing member 318 to return to a natural state, the carriage 200 is secured in the third recline position of FIG. 20 by the locking element 308 engaging the locking bars 210a and 210b, as previously discussed. The carriage 200 could also be returned to the first recline state, such that the forward end 222 of the platform 202 moves upward relative to the base anchor 300 and a headrest portion 224 of the carriage 200 moves downward relative to the base anchor in the first reclining movement, and wherein a seating angle of the carriage is maintained constant.

Clause 1. A juvenile seat comprising: a base anchor having an upper surface and a lower surface; a carriage secured with and moveable relative to the base anchor, the carriage comprising a platform, the platform having an upper surface and a lower surface, the carriage further comprising a recess passing through both of the upper surface of the platform and the lower surface of the platform; and a locking bar, the locking bar positioned in the recess and exposed through the lower surface of the platform, wherein the locking bar is capable of selectively fixing a moveable position of the carriage relative to the base anchor.

Clause 2. The juvenile seat of clause 1, further comprising an arcuate portion positioned at a rear of the carriage and extending to the lower surface of the platform.

Clause 3. The juvenile seat of clauses 1-2, wherein the upper surface of the anchor base has an arcuate surface.

Clause 4. The juvenile seat of clauses 1-3, further comprising an arcuate portion positioned at a rear of the carriage and extending to the lower surface of the platform, wherein the upper surface of the anchor base has an arcuate surface, and wherein the arcuate portion slidably engages the arcuate surface such that the carriage is movable relative to the base anchor.

Clause 5. The juvenile seat of clauses 1-4, wherein the arcuate portion slidably engages the arcuate surface in a first reclining movement, wherein a forward end of the platform is moved upward relative to the base anchor and a headrest portion of the carriage moves downward relative to the base anchor in the first reclining movement, and wherein a seating angle of the carriage is maintained constant.

Clause 6. The juvenile seat of clauses 1-5, wherein the arcuate portion slidably engages the arcuate surface in a second reclining movement, wherein a forward end of the platform is moved downward relative to the base anchor and a headrest portion of the carriage moves upward relative to the base anchor in the second reclining movement, and wherein a seating angle of the carriage is maintained constant.

Clause 7. The juvenile seat of clauses 1-6, the locking bar comprises a rack and wherein the rack mechanically engages a locking element of the base anchor.

Clause 8. The juvenile seat of clauses 1-7, wherein the base anchor comprises a locking element, wherein the locking element mechanically engages the locking bar.

Clause 9. The juvenile seat of clauses 1-8, wherein the locking element comprises an engagement projection, and wherein the engagement projection mechanically engages the locking bar to selectively fix a moveable position of the carriage relative to the base anchor.

Clause 10. A juvenile seat comprising: a base anchor having an upper surface and a lower surface, the upper surface of the anchor base having an arcuate surface, the base anchor further comprising a locking element; a carriage secured with and moveable relative to the base anchor, the carriage comprising a platform, the platform having an upper surface and a lower surface, the carriage further comprising a recess passing through both of the upper surface of the platform and the lower surface of the platform; a locking bar, the locking bar positioned in the recess and exposed through the lower surface of the platform, wherein the locking bar is capable of being mechanically engaged by the locking element to selectively fix a moveable position of the carriage relative to the base anchor; and an arcuate portion, the arcuate portion positioned at a rear of the carriage and extending to the lower surface of the platform, the arcuate portion slidably engaging the arcuate surface of the base anchor.

Clause 11. The juvenile seat of clause 10, further comprising a frame, wherein the locking bar and the arcuate portion are secured to the frame.

Clause 12. The juvenile seat of clauses 10-11, wherein the locking element comprises an engagement projection, and wherein the engagement projection mechanically engages the locking bar that is exposed through the lower surface of the platform to selectively fix a moveable position of the carriage relative to the base anchor.

Clause 13. The juvenile seat of clauses 10-12, wherein the locking bar comprises a rack having a plurality of teeth, wherein the locking element comprises an engagement projection, and wherein the engagement projection mechanically engages one or more of the plurality of teeth to selectively fix a moveable position of the carriage relative to the base anchor.

Clause 14. The juvenile seat of clauses 10-13, wherein the movable position of the carriage relative to the base anchor is determined by one or more of the plurality of teeth that are mechanically engaged by the engagement projection.

Clause 15. The juvenile seat of clauses 10-14, wherein the locking bar comprises a rack having a plurality of teeth, wherein the recess has a flange forming an aperture at the lower surface, wherein one or more of the plurality of teeth of the rack are exposed through the aperture at the lower surface, for mechanical engagement with the locking element of the base anchor.

Clause 16. The juvenile seat of clauses 10-15, wherein when the locking bar is not mechanically engaged by the locking element, the carriage is moveable relative to the base anchor based on the arcuate portion slidably engaging the arcuate surface of the base anchor.

Clause 17. The juvenile seat of clauses 10-16, wherein the carriage is moveable relative to the base anchor in a first reclining movement, wherein a forward end of the platform is moved upward relative to the base anchor and a headrest portion of the carriage moves downward relative to the base anchor in the first reclining movement, and wherein a seating angle of the carriage is maintained constant.

Clause 18. The juvenile seat of clauses 10-17, wherein the carriage is moveable relative to the base anchor in a second reclining movement, wherein a forward end of the platform is moved downward relative to the base anchor and a headrest portion of the carriage moves upward relative to the base anchor in the second reclining movement, and wherein a seating angle of the carriage is maintained constant.

Clause 19. The juvenile seat of clauses 10-18, further comprising a biasing member and a handle, the handle for selectably modifying the locking element from a position that mechanically engages the locking bar to another position that disengages the locking bar, wherein the biasing member biases the handle to selectably modify the locking element to mechanically engage the locking bar.

Clause 20. A juvenile seat comprising: a frame; a base anchor having an upper surface and a lower surface, the upper surface of the anchor base having an arcuate surface, and the base anchor further comprising a locking element having an engagement member; a carriage secured with and moveable relative to the base anchor, the carriage comprising a platform, the platform having an upper surface and a lower surface, the carriage further comprising a recess passing through both of the upper surface of the platform and the lower surface of the platform; a locking bar secured to the frame, the locking bar having a rack with a plurality of teeth, the locking bar positioned in the recess such that one or more of the plurality of teeth are exposed through the lower surface of the platform, wherein the plurality of teeth are capable of being mechanically engaged by the engagement member to selectively fix a moveable position of the carriage relative to the base anchor; and an arcuate portion secured to the frame, the arcuate portion positioned at a rear of the carriage and extending to the lower surface of the platform, the arcuate portion slidably engaging the arcuate surface of the base anchor.

While particular exemplary aspects have been described, it is not intended that the claims be limited thereto, as it is intended that the claims be as broad in scope as the art will allow and that the specification be read likewise. That is, the foregoing description of specific aspects will so fully reveal the general nature of the disclosure that others may, by applying knowledge within the skill of the art, readily modify and/or adapt for various applications such specific aspects, without undue experimentation, without departing from the general concept of the present disclosure. Therefore, such adaptations and modifications are intended to be within the meaning and range of equivalents of the disclosed aspects, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

It will be appreciated by those of ordinary skill in the art that the components, method steps, and materials illustrated above may be varied by substitution of equivalent components, steps, and materials capable of performing the same functions. It will also be appreciated by one of ordinary skill in the art that sizes and strengths of the components may be scaled up or down as required for specific purposes. The claims hereof are intended to encompass all such equivalent components, method steps and scales.

What is claimed is:

1. A juvenile seat comprising:
a base anchor having an upper surface and a lower surface;
a carriage secured with and moveable relative to the base anchor, the carriage comprising a platform, the platform having an upper surface and a lower surface, the carriage further comprising a recess passing through both of the upper surface of the platform and the lower surface of the platform; and
a locking bar, the locking bar positioned in the recess and exposed through the lower surface of the platform, wherein the locking bar is capable of selectively fixing a moveable position of the carriage relative to the base anchor.

2. The juvenile seat of claim 1, further comprising an arcuate portion positioned at a rear of the carriage and extending to the lower surface of the platform.

3. The juvenile seat of claim 1, wherein the upper surface of the anchor base has an arcuate surface.

4. The juvenile seat of claim 1, further comprising an arcuate portion positioned at a rear of the carriage and extending to the lower surface of the platform, wherein the upper surface of the anchor base has an arcuate surface, and wherein the arcuate portion slidably engages the arcuate surface such that the carriage is movable relative to the base anchor.

5. The juvenile seat of claim 4, wherein the arcuate portion slidably engages the arcuate surface in a first reclining movement, wherein a forward end of the platform is moved upward relative to the base anchor and a headrest portion of the carriage moves downward relative to the base anchor in the first reclining movement, and wherein a seating angle of the carriage is maintained constant.

6. The juvenile seat of claim 4, wherein the arcuate portion slidably engages the arcuate surface in a second reclining movement, wherein a forward end of the platform is moved downward relative to the base anchor and a headrest portion of the carriage moves upward relative to the base anchor in the second reclining movement, and wherein a seating angle of the carriage is maintained constant.

7. The juvenile seat of claim 1, the locking bar comprises a rack and wherein the rack mechanically engages a locking element of the base anchor.

8. The juvenile seat of claim 1, wherein the base anchor comprises a locking element, wherein the locking element mechanically engages the locking bar.

9. The juvenile seat of claim 8, wherein the locking element comprises an engagement projection, and wherein the engagement projection mechanically engages the locking bar to selectively fix a moveable position of the carriage relative to the base anchor.

10. A juvenile seat comprising:
a base anchor having an upper surface and a lower surface, the upper surface of the anchor base having an arcuate surface, the base anchor further comprising a locking element;
a carriage secured with and moveable relative to the base anchor, the carriage comprising a platform, the platform having an upper surface and a lower surface, the carriage further comprising a recess passing through both of the upper surface of the platform and the lower surface of the platform;
a locking bar, the locking bar positioned in the recess and exposed through the lower surface of the platform, wherein the locking bar is capable of being mechanically engaged by the locking element to selectively fix a moveable position of the carriage relative to the base anchor; and
an arcuate portion, the arcuate portion positioned at a rear of the carriage and extending to the lower surface of the platform, the arcuate portion slidably engaging the arcuate surface of the base anchor.

11. The juvenile seat of claim 10, further comprising a frame, wherein the locking bar and the arcuate portion are secured to the frame.

12. The juvenile seat of claim 10, wherein the locking element comprises an engagement projection, and wherein the engagement projection mechanically engages the locking bar that is exposed through the lower surface of the platform to selectively fix a moveable position of the carriage relative to the base anchor.

13. The juvenile seat of claim 10, wherein the locking bar comprises a rack having a plurality of teeth, wherein the locking element comprises an engagement projection, and wherein the engagement projection mechanically engages one or more of the plurality of teeth to selectively fix a moveable position of the carriage relative to the base anchor.

14. The juvenile seat of claim 13, wherein the movable position of the carriage relative to the base anchor is determined by one or more of the plurality of teeth that are mechanically engaged by the engagement projection.

15. The juvenile seat of claim 10, wherein the locking bar comprises a rack having a plurality of teeth, wherein the recess has a flange forming an aperture at the lower surface, wherein one or more of the plurality of teeth of the rack are exposed through the aperture at the lower surface, for mechanical engagement with the locking element of the base anchor.

16. The juvenile seat of claim 10, wherein when the locking bar is not mechanically engaged by the locking element, the carriage is moveable relative to the base anchor based on the arcuate portion slidably engaging the arcuate surface of the base anchor.

17. The juvenile seat of claim 16, wherein the carriage is moveable relative to the base anchor in a first reclining movement, wherein a forward end of the platform is moved upward relative to the base anchor and a headrest portion of the carriage moves downward relative to the base anchor in the first reclining movement, and wherein a seating angle of the carriage is maintained constant.

18. The juvenile seat of claim 16, wherein the carriage is moveable relative to the base anchor in a second reclining movement, wherein a forward end of the platform is moved downward relative to the base anchor and a headrest portion of the carriage moves upward relative to the base anchor in the second reclining movement, and wherein a seating angle of the carriage is maintained constant.

19. The juvenile seat of claim 10, further comprising a biasing member and a handle, the handle for selectably modifying the locking element from a position that mechanically engages the locking bar to another position that disengages the locking bar, wherein the biasing member biases the handle to selectably modify the locking element to mechanically engage the locking bar.

20. A juvenile seat comprising:
a frame;
a base anchor having an upper surface and a lower surface, the upper surface of the anchor base having an arcuate surface, and the base anchor further comprising a locking element having an engagement member;
a carriage secured with and moveable relative to the base anchor, the carriage comprising a platform, the platform having an upper surface and a lower surface, the carriage further comprising a recess passing through both of the upper surface of the platform and the lower surface of the platform;
a locking bar secured to the frame, the locking bar having a rack with a plurality of teeth, the locking bar positioned in the recess such that one or more of the plurality of teeth are exposed through the lower surface of the platform, wherein the plurality of teeth are capable of being mechanically engaged by the engagement member to selectively fix a moveable position of the carriage relative to the base anchor; and
an arcuate portion secured to the frame, the arcuate portion positioned at a rear of the carriage and extending to the lower surface of the platform, the arcuate portion slidably engaging the arcuate surface of the base anchor.
